(19) United States
(12) Patent Application Publication
(10) Pub. No.: US 2017/0115371 A1
(43) Pub. Date: Apr. 27, 2017

(54) SYSTEM AND METHOD FOR MANAGING MULTIPLE ROVING ASSETS WITH MULTIPLE DIRECTIONAL BROADBAND ANTENNA SYSTEMS

(71) Applicant: BATS, INC., Indianapolis, IN (US)

(72) Inventor: Alex Eaton, Sheridan, IN (US)

(21) Appl. No.: 15/317,406

(22) PCT Filed: Jun. 9, 2015
(86) PCT No.: PCT/US15/34959

§ 371 Date: Dec. 8, 2016

Related U.S. Application Data
(60) Provisional application No. 62/009,578, filed on Jun. 9, 2014.

(51) Int. Cl. G01S 3/38; H01Q 3/02; H01Q 1/34

(52) U.S. Cl. CPC G01S 3/38; H01Q 1/34; H01Q 3/02; H04W 84/18

(57) ABSTRACT

A communications system is provided comprising a first alignment system coupled to a first antenna and configured to establish a communications link with a first communication source; a second alignment system coupled to a second antenna and configured to establish a communications link with a second communication source. The system further includes a controller coupled to the first alignment system and the second alignment system, the controller configured to provide at least one control signal to cause at least one of the first antenna to establish a communications link with the first communication source and the second antenna to establish a communications link with the second communication source. In one embodiment the first alignment system initiates an optimization sequence in response to the first antenna establishing a communications link with the first communications source and wherein the second alignment system initiates an optimization sequence in response to the second antenna establishing a communications link with the second communications source.

### CROSS-REFERENCE TO RELATED APPLICATION

This application claims the benefit of U.S. Provisional Application Ser. No. 62/009,578, filed on Jun. 9, 2014, the disclosure of which is expressly incorporated herein by reference.

### FIELD OF THE DISCLOSURE

The present application generally relates to wireless broadband communications systems. More particularly, the present application relates to a system and a method for managing multiple roving assets with directional broadband antenna systems.

### BACKGROUND

Various communications systems are known in the art which allow roving assets, such as platforms, maritime vessels, aircraft, or terrain vehicles, to communicate with other moving vehicles or fixed communication installations using wireless methods. One such method is to use satellite communications to allow the roving asset to communicate with the intended target. Satellite communications suffer from significant drawbacks, such as limited bandwidth, increased latency, and instability due to weather conditions or other environmental effects. Satellite communications require a relay from the initial source (VSAT Antenna), namely a middle source such as an orbiting satellite, to the intended source (Land Earth Station). On the other hand, Broadband Ethernet Radio systems and Digital Microwave Radio systems are terrestrial based and do not require this intermediary source. In another embodiment, a single fixed antenna on the roving asset is used to establish communications with another roving asset or communication node using a broadband wireless communications network. However, in addition to the challenges presented by the movement of the roving asset in relation to the communication target, it may be difficult to maintain communications with multiple communication sources using a single fixed antenna, as is often required in multi-vessel or roving asset communications environments, such as mesh networks. Commonly-used omnidirectional antennas in such wireless systems are also not always capable of achieving the desired combination of operating distance, and bandwidth speed necessary in modem data and video communications.

In current mobile communications systems, the majority of the antennas, are single structures providing omni-directional Radio Frequency (“RF”) coverage and are mounted in the same plane as other antennas on the top side of mobile platforms. This structure may cause co-site interference between systems as well as creating high visibility of antenna systems and may cause obstructions. Previous efforts to resolve these issues replaced the single omni-directional antenna with multiple low profile/conformal directional apertures and mounted these apertures on the side of the terrestrial roving asset. By distributing the RF power equally amongst the apertures and placing them out of sight from the top side, omni-directional coverage could be achieved and the visual signature and the co-site interference issues were alleviated. However, these distributed antenna systems are not without their own short comings. These antenna systems are passive and, as such, do not take full advantage of the benefits of the directional capabilities of the distributed antennas. Through the use of a passive splitter combiner, the distributed system directs the RF radiation in an omni-directional pattern; however, as there is no active control of the RF path, the system does not make full use of the benefits that distributed directional antennas provide such as directional networking, nulling, and increased effective isotropic radiated power.

Therefore, improved communications systems are needed to assist in locating, locking onto, optimizing, and tracking the data links associated with antenna systems of the aforementioned roving assets. The following claims outline methods for accomplishing and improving these processes.

### SUMMARY OF THE DISCLOSURE

In one embodiment of the present disclosure a communications system is provided comprising: a first alignment system coupled to a first antenna and configured to establish a communications link with a first communication source; a second alignment system coupled to a second antenna and configured to establish a communications link with a second communication source; and a controller coupled to the first alignment system and the second alignment system, the controller configured to provide at least one control signal to cause at least one of the first antenna to establish a communications link with the first communication source and the second antenna to establish a communications link with the second communication source; wherein the first alignment system initiates an optimization sequence in response to the first antenna establishing a communications link with the first communications source and wherein the second alignment system initiates an optimization sequence in response to the second antenna establishing a communications link with the second communications source.

In another embodiment of the present disclosure, a method in a communications system is provided comprising: providing a first alignment system coupled to a first antenna and configured to establish a communications link with a first communication source; providing a second alignment system coupled to a second antenna and configured to establish a communications link with a second communication source; transmitting, via the first antenna, a communication signal to the first communication source indicating initiation of a first optimization process; performing, via the first antenna, the first optimization process based on receipt of a communication signal from the first communication source indicating acknowledgment of the initiation of the first optimization process; performing, via the second antenna, an second optimization process based on receipt of a communication signal from the second communication source indicating completion of the first optimization process; determining, via the first alignment system, if additional optimization stages are required wherein additional optimization stages comprises restarting the first optimization process; and determining, via the second alignment system, if additional optimization stages are required wherein additional optimization stages comprises restarting the second optimization process.

Additional features and advantages of the present disclosure will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a functional block diagram of a system including two independent antenna systems mounted onto two roving assets according to one embodiment of the present disclosure;

FIG. 2 is flow diagram of a communications method implemented with the system of FIG. 1 according to one embodiment of the present disclosure;

FIG. 3A-3C is a diagrammatic aerial view of exemplary roving assets providing beams according to one embodiment of the present disclosure;

FIG. 4A is a diagrammatic aerial view of exemplary roving assets having unaligned antenna beams according to one embodiment of the present disclosure;

FIG. 4B is a diagrammatic aerial view of exemplary roving assets using ultra-high frequency (“UHF”) transmission of alignment data according to one embodiment of the present disclosure;

FIG. 4C-4D is a another diagrammatic aerial view of exemplary roving assets providing beams according to one embodiment of the present disclosure;

### DETAILED DESCRIPTION OF THE DRAWINGS

The embodiments of the present disclosure described herein are not intended to be exhaustive or to limit the disclosure to precise forms disclosed. Rather, the embodiments selected for description have been chosen to enable one skilled in the art to practice the invention. For the purposes of promoting and understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications in the described embodiments, and any further application of the principles of the disclosure as described herein are contemplated as would normally occur to one skilled in the art to which the disclosure relates.

For the purpose of illustration the term “system” will be used to describe the combination of hardware, software, interfaces, and features that help perform operational communications, through the means of automatically aligning, scanning, optimizing, tracking, or switching of Radio Frequency (“RF”) antennas to establish or maintain a wireless data link. The antennas may be directional in nature to allow communication with distant sources, but should not be limited due to different reception characteristics, such as gain levels, beam widths, or other such differences.

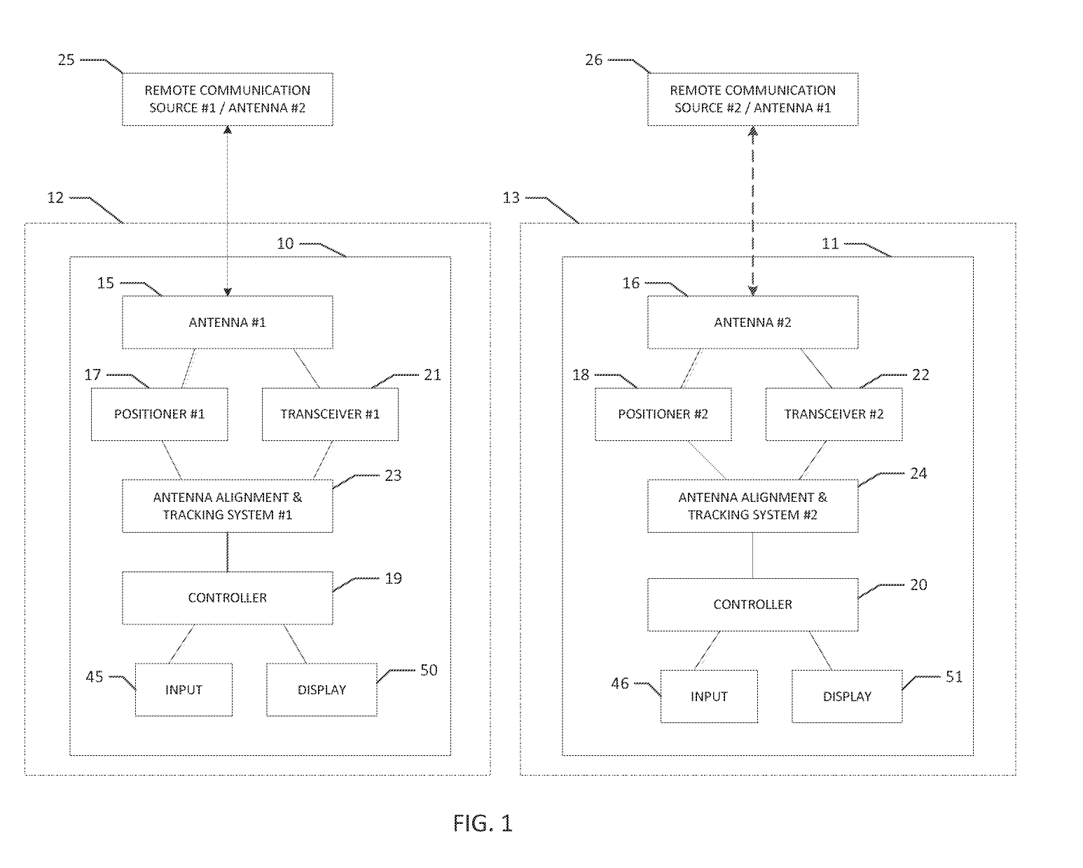

FIG. 1 illustrates at least two systems 10 and 11 for managing antennas 15 and 16 respectively. As shown, system 10 is mounted onboard a vehicle/roving asset 12 while system 11 is mounted onboard a vehicle/roving asset 13. Exemplary roving assets include vehicles, aircraft, maritime vessels, or terrain vehicles. First antenna 15 and second antenna 16 may be directional in nature to allow communication with distant sources, but may have substantially different reception characteristics, such as gain levels, beam widths, or other differences due to their mounting locations on the roving asset. Due to their different reception characteristics, one of the antennas may be capable of communicating over great distances (e.g., 50 miles or more), while another antenna may be relatively limited in its reception capabilities. It shall be understood that the range of both antennas may be higher or lower than 50 miles, and the mentioned range is only one non-limiting example of the ranges contemplated to be within the scope of the present disclosure. Antennas 15 and 16 are each respectively connected to a first positioner 17 and a second positioner 18 and a first transceiver 21 and second transceiver 22 as shown in the illustrative embodiment of FIG. 1. Positioners 17 and 18 comprise the hardware (motors, gearing, etc.) necessary to physically move or rotate the antennas about a horizontal and vertical axis. In embodiment, positioners 16 and 17 may comprise a mechanical positioner such as RF switching mechanism, electronic array, beam forming, or any other such method of adjusting the direction of the antenna. An RF switching mechanism may be a broadband multi-position coaxial switch designed to switch RF signals from one input port to another. Through the use of the positioner, RF switch, or other such device the antenna may be physically rotated and moved about horizontal and vertical axis and/or may be electronically steered. Transceivers 21 and 22 provide for the tuning, amplification and other processing of the signals received and transmitted by antennas 15 and 16.

In the illustrative embodiment of FIG. 1, first antenna 15 is operatively connected to first antenna and alignment tracking system (AATS) 23 while second antenna 16 is operatively connected to second antenna and alignment tracking system (AATS) 24. AATS 23, via positioner 17 and transceiver 21, automatically senses and/or tracks a desired signal or signal source location, and may also account for changes in the roving asset's position. Likewise, AATS 24, via positioner 18 and transceiver 22, automatically senses and/or tracks a desired signal or signal source location, and may also account for changes in the vehicle's or roving asset's position. In one embodiment, AATS 23 and 24, accounts for changes in the movement or position of a vehicle or roving asset through use of magnetometers, gyroscopic instruments, Global Positioning System and Heading devices, or other such methods. Positioners, RF switches, transceivers, and/or antennas may be included within each AATS 23 and 24 or provided as separate components. One example of a suitable AATS which contains a positioner, transceiver, antenna, and associated control components is the model DVM-30/RMCU-STD system supplied by Broadband Antenna Tracking Systems Inc. 8341 Georgetown Rd, Indianapolis, Ind. 46268. It shall be further understood that more than two antennas, positioners, transceivers and AATS units may be provided and operated using system 10 or system 11 to communicate with more than two corresponding remote broadband communication sources.

System 10 and system 11 each further comprises a controller 19 and a controller 20 respectively, wherein each controller is in operative communication with each AATS' 23 and 24 as shown. Controller 19 and 20 may each provide one or more control signals to selectively pair the individual respective antennas 15 and 16 with signals or sources based on various optimization criteria as discussed in detail below. In certain embodiments, controllers 19 and 20 may contain information relating to signal sources in addition to those detected during one or more scanning processes. For example, controller 19 and controller 20 may each be preloaded with a list of all of the available signal sources in the network and their associated properties. In other embodiments, controller 19 and 20 may determine the list of available signals from the information received during the scan process. In still further embodiments, controller 19 and controller 20 may also each provide node awareness or other information to other roving assets or signal sources in the network based on the information preloaded in or dynamically determined by controller 19 and 20.

In certain embodiments of the present disclosure, antennas 15 and 16 enable two-way broadband wireless communication with two or more remotely located communication sources 25 and 26. In one embodiment, remote communication sources 25 and 26 may comprise any device capable of transmitting or receiving broadband signals using a wireless protocol. One example of such a device is a Wireless Access Point which conforms to IEEE 802.16 or IEEE 802.11 standards. Remote communication sources 25 and 26 are typically located on other moving vehicles to collectively form a mesh network. Antennas 15 and 16 send and receive signals to and from remote communication sources 25 and 26, which are likewise directed to and from the roving asset communication subsystems (or retransmitted to other roving assets). Because each roving asset or signal source in the network is also capable of retransmitting signals received from one roving asset to other roving assets, communication over hundreds or even thousands of miles becomes possible. In certain embodiments of the present disclosure first communication source 25 corresponds to second antenna 16 while second communication source 26 corresponds to first antenna 15.

Controller 19 and controller 20 may each comprise a processor for processing data and memory for storing data. Controller 19 and 20 may also be operatively coupled to an input device 45 and 46 respectively and an output display device 50 and 51 respectively for displaying data. As is known in the art, each input device 45 and 46 receives user-entered data and output display device 50 and 51 may be operative to display at least a portion of the user-entered data. Input devices 45 and 46 can include any type of input device known to those skilled in the art, including buttons, microphones, touch screens, keyboards, and the like, to name a few examples. Output devices 50 and 51 include any output device known to those skilled in the art, such as displays, tactile devices, printers, speakers, and the like, to name a few examples. Moreover, it should be recognized that the input device and the output device can be combined to form a single unit such as, for example, a touch-type screen. In other embodiments, system 10 and system 11 may contain fewer or more components. AATS' 23 and 24 may also likewise comprise similar processor, memory, and input/output devices. It shall also be understood that in certain embodiments, the functionality of controller 19 and 20 may be incorporated into one or more of the AATS units 23 or 24.

Controller 19 and controller 20 are used to control the operation of system 10 and 11 by analyzing the various forms of information discussed herein and dictating wireless signal source and antenna pairings and/or antenna movements. Controller 19 and 20 may be comprised of one or more components. For a multi component form, one or more components may be located remotely relative to the others, or configured as a single unit. Furthermore, controller 19 and 20 can be embodied in a form each having more than one processing unit, such as a multi-processor configuration, and should be understood to collectively refer to such configurations as well as a single-processor-based-arrangement. One or more components of the processor may be of electronic variety defining digital circuitry, analog circuitry, or both. The processor can be of a programmable variety responsive to software instructions, a hardwired state machine, or a combination of these.

Among its many functions, the memory of controller 19 and 20 in conjunction with the processor is used to store information pertaining to, such as, but not limited to, antenna position, roving asset location, Global Positioning System (“GPS”) location, heading, speed, services delivered through the network, signal strength, distance between vehicles or vessels etc., on a temporary, permanent, or semi-permanent basis. The memory can include one or more types of solid state memory, magnetic memory, or optical memory, just to name a few. By way of non-limiting example, the memory can include solid state electronic random access memory (RAM), sequential access memory (SAM), such as first-in, first-out (FIFO) variety or last-in, first-out (LIFO) variety, programmable read only memory (PROM), electronically programmable read only memory (EPROM), or electronically erasable programmable read only memory (EEPROM); an optical disc memory (such as a blue-ray, DVD or CD-ROM); a magnetically encoded hard disc, floppy disc, tape, or cartridge media; or a combination of these memory types. In addition, the memory may be volatile, non-volatile, or a hybrid combination of volatile, non-volatile varieties. The memory can further include removable types of memory. The removable memory can be in the form of a non-volatile electronic memory unit, optical memory disk (such as a blue ray, DVD or CD ROM); a magnetically encoded hard disk, floppy disk, tape, or cartridge media; a USB memory drive; or a combination of these or other removable memory types.

In one embodiment of the present disclosure, AATS 23 may obtain an estimate of a pointing angle of first antenna 15 through means such as sampling, scanning, or other such means that would be apparent to one skilled in the art of antenna alignment. Likewise, AATS 24 may also be obtain an estimate of a pointing angle of second antenna 16 through such means as noted above in connection with antenna 15. As described in more detail below, once a relative pointing angle has been established, AATS 23 or AATS 24 may perform an optimization sequence to refine the pointing angle in order to achieve the highest quality of signal parameters or enhanced communications signal integrity. In one embodiment, the optimization sequence or pattern may occur while one or both of antennas 15 and 16 are in motion. In another embodiment, when AATS 23 initiates an optimization sequence, AATS 24 causes second antenna 16 to remain in a fixed position until AATS 23 completes the optimization sequence. Additionally, when AATS 24 initiates an optimization sequence, AATS 23 causes first antenna 15 to remain in a fixed position until AATS 24 completes the optimization sequence.

Traditional methods for antenna optimization may use a timing based optimization wherein the first antenna “Master” would perform an optimization sequence while the second antenna “Slave” would hold its position steady for a specified time interval. After the time interval the roles would reverse in which the “Master” antenna would hold steady while the “Slave” antenna would perform the optimization sequence for the specified time interval. This timing based optimization method contains the potential for errors as both systems must be synchronized based on movement speed, pattern type, pattern size, time delay increment, and other such variables.

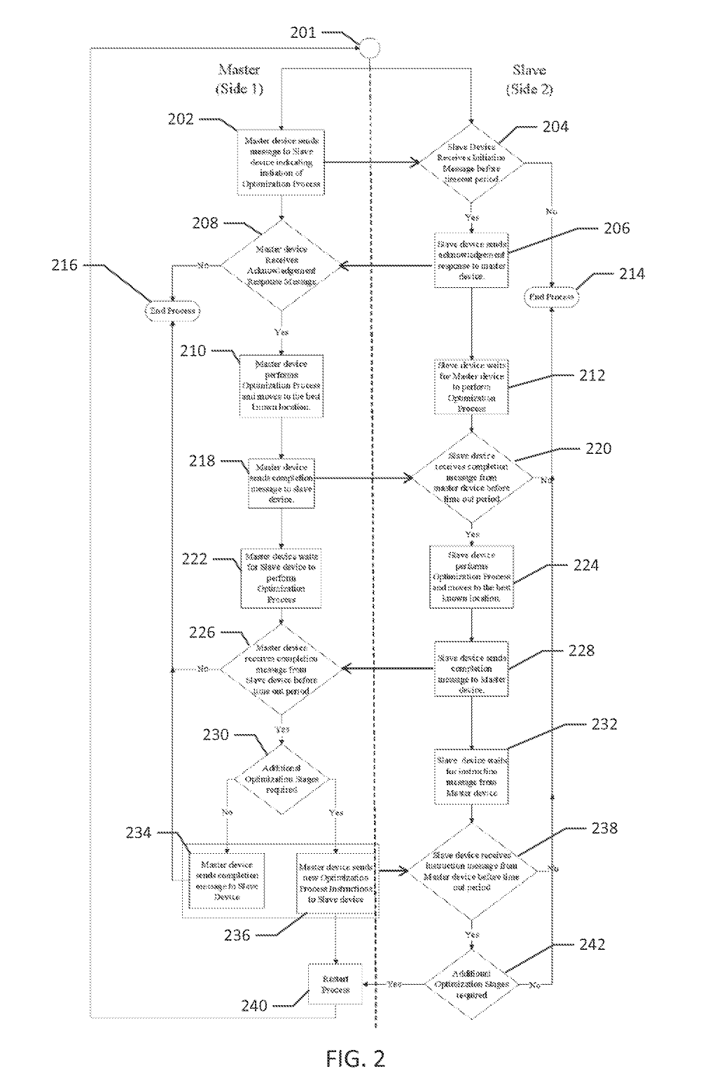

As described in more detail in the disclosed embodiment of FIG. 2, the present disclosure provides a synchronized method of adjusting two or more antennas by passing a signal between two systems, namely AATS 23 and second alignment system 25, one on either side of a data communications link, to assist in the alignment and optimization of the antennas thereby substantially mitigating the potential for error associated with timing based optimization. Specifically, timing based optimization is most prone to error when aligning and tracking small beam width antennas (less than one degree beam width) during Communication On-The-Move scenarios. However, the present disclosure provides synchronized methods for passing a data or communications signal between multiple systems that may be applied to antennas with any degree of beam width. In one embodiment, the signal may be in the form of an encrypted data packet, an unencrypted data packet, a beacon, transmission of location data, transmission of GPS coordinates, or other such methods that one skilled in the art of RF Engineering could interpret as a method for communicating data. In one embodiment, the signal that is passed between the AATS 23 and AATS 24 may be delivered by way of a negotiated/established data link or through an alternate route.

FIG. 2 is flow diagram of an exemplary method operable in the system of FIG. 1 according to one embodiment of the present disclosure. In one illustrative embodiment of FIG. 2, a synchronous optimization method is disclosed wherein, for example, first antenna 15, via AATS 23, performs an optimization sequence while second antenna 16, via AATS 24, holds its position steady until a signal comprising an instruction is communicated. Once first antenna 23 completes the optimization process the roles would reverse in which first antenna 15, via AATS 23, would hold steady while the second antenna 16 performs the optimization sequence. In one embodiment the optimization pattern size, pattern type, movement speed, and other such variables may be dictated from one system to the other, negotiated between systems, or specific to an individual system. The illustrative embodiment of FIG. 2 provides an exemplary method of performing a synchronous optimization that includes one or more of above mentioned steps. Other embodiments for synchronous optimization are foreseeable and it should be understood that no limitation to the scope of the synchronous optimization is intended. Any further applications of the principles of synchronous optimization are contemplated as is known to one skilled in the art. In one embodiment, the disclosed synchronized routine may occur once or multiple times and may consists of varying areas of coverage. For example, the area of coverage may progressively expand or contract with each progression of the optimization process.

In one embodiment, AATS 23 and 24 share location information, including GPS Coordinates, connection status including awareness of other devices accessible to AATS 23 and accessible to AATS 24, quality of signal information, signal-to-noise ratio, and messages such as but not limited to synchronization information, and other such information pertaining to immediate system status or the status of additional systems for the purposes of aiding and assisting in the alignment and/or optimization of first antenna 15 and second antenna 16. In one embodiment, the above mentioned signal that is passed between AATS 23 and 24 may be an Internet Protocol (“IP”) data packet, a User Datagram Protocol (“UDP”) data packet, Transmission Control Protocol (“TCP”) data packet, or any such data packet/structure including but not be limited to an encrypted data structure and an unencrypted data structure. In yet another embodiment, the present disclosure provides that the communications relating to, for example, the optimization sequence performed by either AATS 23 and AATS 24 may be deployed in conjunction with traditional omni-directional RF antennas, satellite, Very High Frequency (“VHF”) radios, Ultra High Frequency (“UHF”) radios, RF transmission, Cellular networks, beaconing, electronic or electromagnetic signaling, or other such means of data transmission capable of sending/transmitting an IP data packet, an RF signal, or other such form of communication to assist in the alignment and optimization of first antenna 15 and second antenna 16. Any “out of band” methods disclosed above may not provide the desired data pipe (data rates, throughput, bandwidth, or quality of signal) for an end use application but may be sufficient as a method to pass information as described in the present disclosure and method 200 to accomplish optimization and synchronization instructions provided below.

Referring again to FIG. 2, method 200 begins at start block 201 and proceeds to the master side. At block 202A, a master device sends a message to a slave device, the message indicating initiation of an optimization process. In one embodiment, an exemplary master device comprises AATS 23 coupled to first antenna 15 and an exemplary slave device comprises AATS 24 coupled to first antenna 16. Method 200 then proceeds to decision block 204, wherein, if the slave device receives the initiation message before a predetermined time period, the method proceeds to block 206, however if the slave device does not receive the initiation message before the predetermined time period the method proceeds to block 214 and method 200 ends. In various embodiments of the present disclosure, the predetermined time period may also be referred as a timeout period wherein a particular device is programmed or configured to receive and/or detect receipt of a signal during a first predetermined time period. In various other embodiments, one more messages may be provided to the slave device from the master device and from the master device to the slave device. In one embodiment the messages may be in form of an RF signal, data communications signal, or any other electronic or electromagnetic signal capable of transmitting data communications wherein the signal may have either a digital or analog characteristic.

At block 206, the slave device sends an acknowledgement response to the master device. In certain embodiments of method 200, the method may split and proceed partially to the master side while also proceeding toward one or more blocks on the slave side. In one embodiment, method 200 proceeds to decision block 208 wherein, if the master device receives the acknowledgment response message from the slave device, the method proceeds to block 210, however if the master device does not receive the acknowledgement response message from the slave device the method proceeds to block 216 and method 200 ends. In another embodiment, method 200 likewise proceeds to block 212 on the slave side wherein the slave device waits for the master device to perform the optimization process.

At block 210 of method 200, the master device performs the optimization process wherein antenna 15 moves and/or orients to the best known location/position. In various embodiments, the best known location/position may correspond to, for example, a pointing angle of antenna 15 that achieves the highest quality of signal parameters, enhanced communications signal integrity, or highest signal-to-noise ratio. The method then proceeds to block 218 wherein the master device sends a completion message to the slave device. At decision block 220, if the slave device receives the completion message from the master device before the time out period, the method proceeds to block 224 on the slave side, otherwise the method proceeds to block 214 and method 200 ends. Likewise on the master side, method 200 proceeds to block 222 and the master device waits for the slave device to perform the optimization process. Accordingly, on the slave side, at block 224 the slave device performs the optimization process and moves and/or orients to the best known location/position. As noted above, the best known location/position may correspond to, for example, a pointing angle of antenna 16 that achieves the highest quality of signal parameters, enhanced communications signal integrity, or highest signal-to-noise ratio. Method 200 then proceeds to block 228 and the slave device sends a completion message to the master device. On the master side, method 200 proceeds to decision block 226 wherein, if the master device receives the completion message from the slave device before the time out period, the method proceeds to decision block 230, otherwise the method proceeds to block 216 and method 200 ends.

At decision block 230, method 200 determines if additional optimization stages are required while on the slave side, method 200 proceeds to block 232 and waits for an instruction message from the master device. If additional optimization stages are required method 200 proceeds to block 236 and sends new optimization process instructions to the slave device, otherwise method 200 proceeds to block 234 and the master device sends a completion message to the slave device. On the slave side, method 200 proceeds from block 232 to decision block 238, wherein if the slave device receives an instruction message from the master device before the time out period then the method proceeds to decision block 242, otherwise the method proceeds to block 214 and method 200 ends. At decision block 242 the slave device also determines if additional optimization stages are required. If additional optimization stages are required the method proceeds to block 240 and method 200 restarts at block 201, otherwise the method proceeds to block 214 and method 200 ends. In various embodiments, additional optimization stages on the master side comprises restarting the first optimization process to further refine the alignment and synchronization position of first antenna 15, whereas additional optimization stages on the slave side comprises restarting the second optimization process to further refine the alignment and synchronization position of second antenna 16.

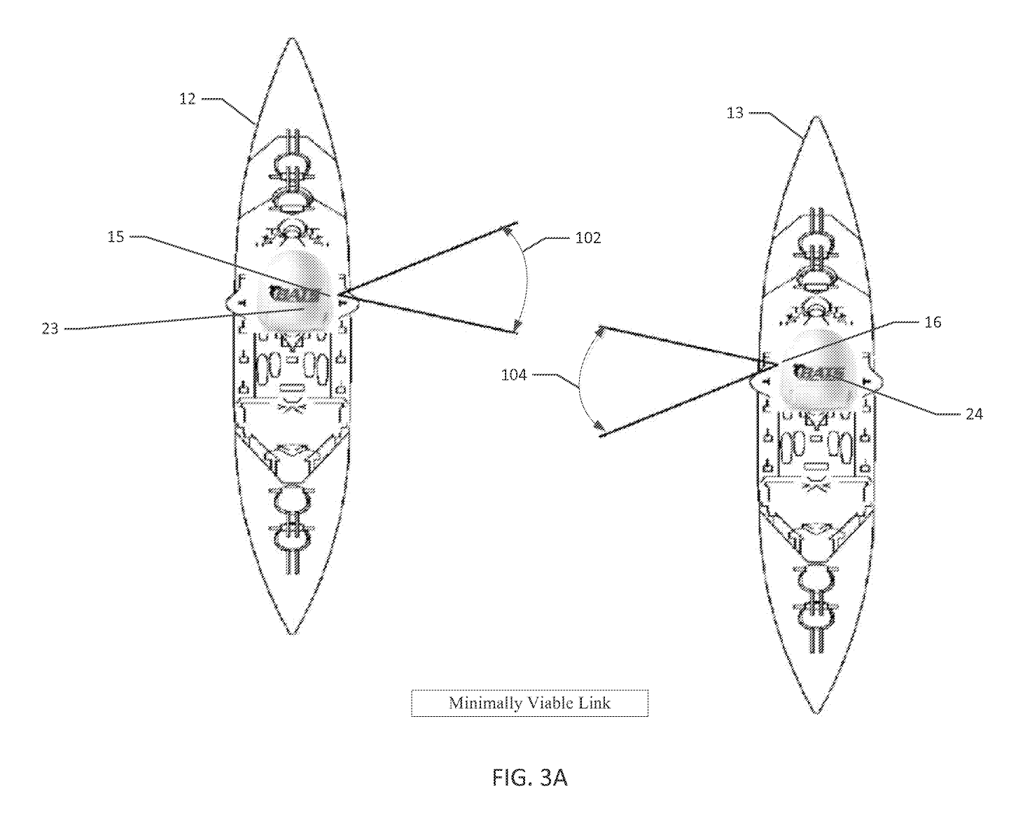

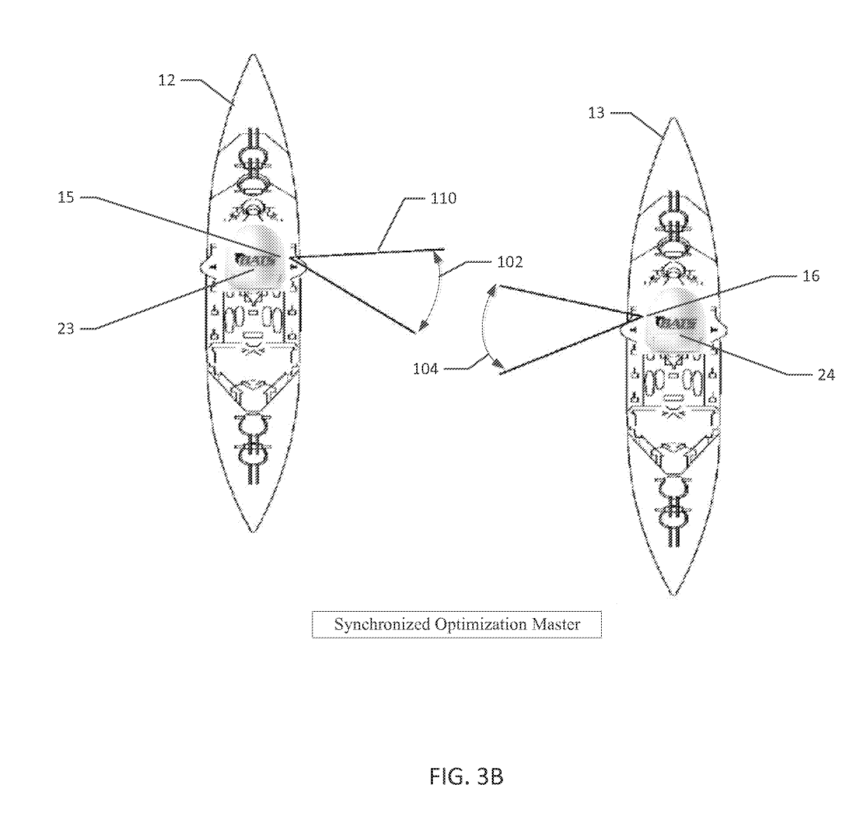

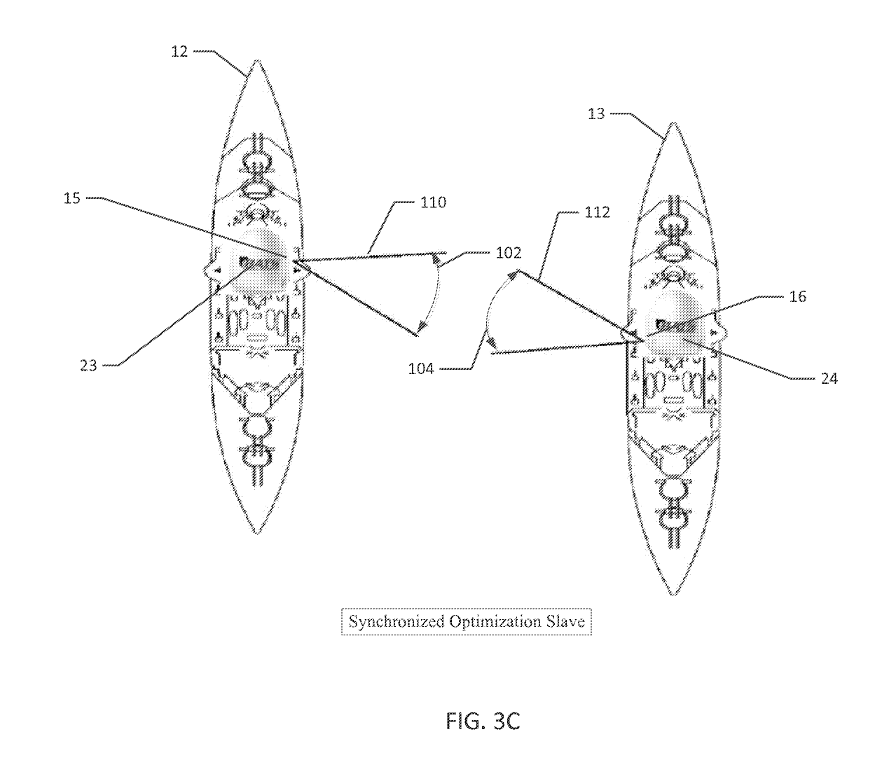

FIG. 3A is a diagrammatic aerial view of roving asset 12 and 13 having a minimally viable data link. In various embodiments of the present disclosure, roving asset 12 may transmit a data communication signal in the form of beam 102 while roving asset 13 transmits a communication signal in the form of beam 104. In the illustrative embodiment of FIG. 3A, roving asset 12 transmits beam 102 via first antenna 15 while roving asset 13 transmits beam 104 via second antenna 16. FIG. 3A includes a minimally viable data link because beam 102 and beam 104 are not in complete alignment such that a point-to-point or line of sight data communications link may be established. As described in more detail below, in certain embodiments of the present disclosure, first antenna 15 and AATS 23 may cooperate to form a master device while second antenna 16 and AATS 24 may cooperate to form a slave device. FIG. 3B depicts a diagrammatic aerial view of roving asset 12 and 13 wherein antenna 15 and beam 102 are in a synchronized optimization position 110, while antenna 16 and beam 104 are not in a synchronized optimization position and therefore not in full alignment with antenna 15 and beam 102. FIG. 3C depicts a diagrammatic aerial view of roving asset 12 and 13 wherein antenna 15 and beam 102 are in synchronized optimization position 110 while antenna 16 and beam 104 are also in a synchronized optimization position 112. In one embodiment, synchronized optimization position 110 of antenna 15 corresponds to block 210 of method 200 wherein the master device performs the optimization process by AATS 23 causing first antenna 15 to move or orient to a best known location/position. Likewise, in yet another embodiment, synchronized optimization position 112 of antenna 16 corresponds to block 224 of method 200 wherein the slave device performs the optimization process by AATS 24 causing second antenna 16 to move or orient to a best known location/position.

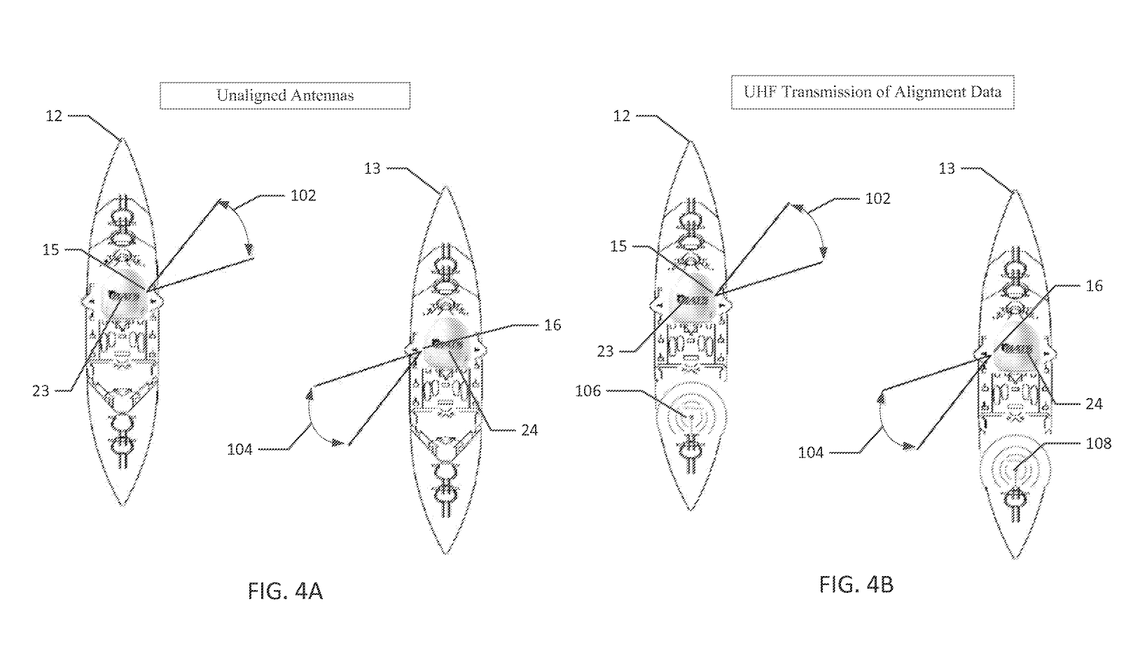

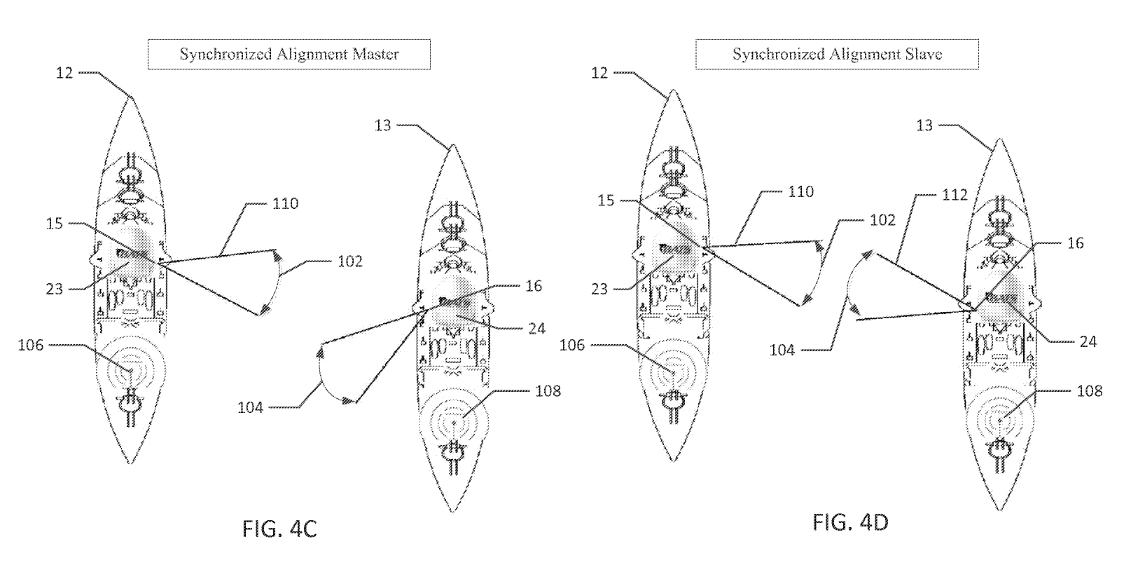

FIG. 4A is a diagrammatic aerial view of roving assets 12 and 13 having unaligned antenna beams hence because beam 102 and beam 104 are not in complete alignment no point-to-point or line of sight data communications link may be established. FIG. 4B is a diagrammatic aerial view of roving asset 12 including a first UHF transmitter 106 and roving asset 13 including a second UHF transmitter 108. As noted above, communications relating to, for example, the optimization sequence of method 200 performed by either AATS 23 or AATS 24 may be deployed in conjunction with traditional omni-directional RF antennas, satellite, Very High Frequency (“VHF”) radios, Ultra High Frequency (“UHF”) radios, RF transmission, Cellular networks, beaconing, electronic or electromagnetic signaling. FIG. 4B provides an exemplary embodiment wherein alignment data communications relating to an optimization process/sequence may be transmitted from AATS 23 to AATS 24 via first UHF transmitter 106 and from AATS 24 to AATS 23 via second UHF transmitter 108.

FIG. 4C depicts a diagrammatic aerial view of roving asset 12 and 13 wherein antenna 15 and beam 102 are in a synchronized optimization position 110, while antenna 16 and beam 104 are not in a synchronized optimization position and therefore not in full alignment with antenna 15 and beam 102. FIG. 4D depicts a diagrammatic aerial view of roving asset 12 and 13 wherein antenna 15 and beam 102 are in synchronized optimization position 110 while antenna 16 and beam 104 are also in a synchronized optimization position 112. In one embodiment, synchronized optimization position 110 is accomplished by way of AATS 23 causing first antenna 15 to move or orient to position 110 via alignment data received through UHF transmitter 106. Likewise, in yet another embodiment, synchronized optimization position 112 is accomplished by way of AATS 24 causing first antenna 16 to move or orient to position 112 via alignment data received through UHF transmitter 108.

In the foregoing specification, specific embodiments of the present disclosure have been described. However, one of ordinary skill in the art will appreciate that various modifications and changes can be made without departing from the scope of the disclosure as set forth in the claims below. Accordingly, the specification and figures are to be regarded in an illustrative rather than a restrictive sense. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

What is claimed is:

1. A communications system comprising:
a first alignment system supported by a first roving asset and coupled to a first antenna and a first controller, the first controller configured to provide at least one control signal to cause the first antenna to establish a first communications link with a first communication source;
a second alignment system coupled to a second antenna and a second controller, the second controller configured to provide at least one control signal to cause the second antenna to cause the second antenna to establish a communications link with the second communication source;
wherein the first alignment system initiates a first optimization sequence in response to the first antenna establishing the first communications link and wherein the second alignment system initiates a second optimization sequence in response to the second antenna establishing the second communications link, and wherein the first communication source corresponds to the second antenna and second communication source corresponds to the first antenna.

2. The communications system of claim 1, wherein the first optimization sequence comprises a timing-based optimization sequence that comprises at least one of providing a first data signal for a first time period, via the first antenna, to the first communication source and providing a second data signal for a second time period, via the second antenna, to the second communication source.

3. The communications system of claim 2, wherein the second optimization sequence comprises a timing-based optimization sequence that comprises at least one of receiving a first data signal for a first time period, via the first antenna, from the first communication source and receiving a second data signal for a second time period, via the second antenna, from the second communication source.

4. The communications system of claim 2, wherein the first data signal and the second signal each comprise at least one of an encrypted data packet, an unencrypted data packet, a beacon, a transmission of location data, a transmission of global positioning system (“GPS”) coordinates, and a change in communication status.

5. The communications system of claim 4, wherein the first data signal and the second data signal each comprise an internet protocol (“IP”) data packet including at least one of a user datagram protocol (“UDP”) packet and a transmission control protocol (“TCP”) packet.

6. The communications system of claim 5, wherein the IP data packet includes at least one of an encrypted IP data packet and an unencrypted IP data packet.

7. The communications system of claim 1, wherein when the first alignment system initiates the first optimization sequence, the second alignment system causes the second antenna to remain in a fixed position until the first alignment system completes the first optimization sequence.

8. The communications system of claim 7, wherein when the second alignment system initiates the second optimization sequence, the first alignment system causes the first antenna to remain in a fixed position until the second alignment system completes the second optimization sequence.

9. The communications system of claim 3, wherein the first optimization sequence comprises one or more characteristics including at least one of a pattern size, pattern type, movement speed, and time delay increment, and wherein the characteristics are specific to the first alignment system.

10. The communications system of claim 3, wherein the second optimization sequence comprises one or more characteristics including at least one of a pattern size, pattern type, movement speed, and time delay increment, and wherein the characteristics are specific to the second alignment system.

11. The communications system of claim 1, wherein the first alignment system is configured to obtain a pointing angle of the first antenna prior to initiating the first optimization sequence and the second alignment system is configured to obtain a pointing angle of the second antenna prior to initiating the second optimization sequence.

12. A method in a communications system comprising:
providing a first alignment system coupled to a first antenna and configured to establish a communications link with a first communication source;
providing a second alignment system coupled to a second antenna and configured to establish a communications link with a second communication source;
transmitting, via the first antenna, a communication signal to the first communication source indicating initiation of a first optimization process;
performing, via the first antenna, the first optimization process based on receipt of a communication signal from the first communication source indicating acknowledgment of the initiation of the first optimization process;
performing, via the second antenna, an second optimization process based on receipt of a communication signal from the second communication source indicating completion of the first optimization process;
determining, via the first alignment system, if additional optimization stages are required wherein additional optimization stages comprises restarting the first optimization process; and
determining, via the second alignment system, if additional optimization stages are required wherein additional optimization stages comprises restarting the second optimization process.

13. The method of claim 12, wherein the first communication source corresponds to the second antenna and second communication source corresponds to the first antenna.

14. The method of claim 13, wherein the second antenna sends a communication signal including an acknowledgment response to the first antenna and the first alignment system causes the first antenna to perform the first optimization process based on receipt of the acknowledgment response.

15. The method of claim 14, wherein the communication signal including the acknowledgment response indicates acknowledgment of the initiation of the first optimization process.

16. The method of claim 14, wherein the second antenna receives the communication signal indicating initiation of the first optimization process before a first timeout period.

17. The method of claim 12, wherein the first alignment system and the first antenna cooperate to form a master device and the second alignment system and the second antenna cooperate to form a slave device.

18. The method of claim 13, wherein performing the first optimization process comprises at least one of the first alignment system causing the first antenna to, orient to a position that provides maximum communication signal integrity, transmit global positioning system (“GPS”) coordinates, transmit connection status information, transmit communication signal quality, transit synchronization information, and transmit information pertaining to the first alignment system.

19. The method of claim 13, wherein performing the second optimization process comprises at least one of the second alignment system causing the second antenna to, orient to a position that provides maximum communication signal integrity, transmit global positioning system (“GPS”) coordinates, transmit connection status information, transmit communication signal quality, transit synchronization information, and transmit information pertaining to the second alignment system.

20. The method of claim 13, wherein performing the first optimization process comprises at least one of the first alignment system causing the first antenna to transmit one or more data communications signal via at least one of beaconing, signaling, UHF transmission, VHF transmission, and Satellite transmission.

21. The method of claim 13, wherein performing the second optimization process comprises at least one of the second alignment system causing the second antenna to transmit one or more data communications signal via at least one of beaconing, signaling, UHF transmission, VHF transmission, and Satellite transmission.
